(19) United States
(12) Patent Application Publication
(10) Pub. No.: US 2003/0206637 A1
(43) Pub. Date: Nov. 6, 2003

(54) Mechanism and method to achieve group-wise perfect backward secrecy

(76) Inventors: Germano Caronni, Palo Alto, CA (US); Radia J. Perlman, Acton, MA (US)

Correspondence Address: ROSENTHAL & OSHA L.L.P. / SUN, 1221 MCKINNEY, SUITE 2800, HOUSTON, TX, 77010, US

(21) Appl. No.: 10/137,994

(22) Filed: May 3, 2002

(51) Int. Cl. H04L 9/00

(52) U.S. Cl. 380/277

(57) ABSTRACT

A method for updating a key in a secure group involves issuing an update request by a first member of the secure group, receiving the update request by a second member of the secure group, generating a first suggested revision number by the first member, generating a second suggested revision number by the second member in response to the update request, calculating a first send time by the first member using the first suggested revision number, calculating a second send time by the second member using the second suggested revision number, sending the first suggested revision number by the first member upon reaching the first send time if the first member is not blocked from sending, sending the second suggested revision number by the second member upon reaching the second send time if the second member is not blocked from sending, receiving the first suggested revision number by the second member, comparing the first suggested revision number to the second suggested revision number by the second member, blocking the second member from sending if the first suggested revision number is more than the second suggested revision number, and updating the key on the first member and the second member using the first suggested revision.

### BACKGROUND OF INVENTION

Distributed applications such as multimedia conferencing, computer-supported collaborative work, distributed computing, and remote consultation and diagnosis systems for medical applications depend on efficient information exchange among multiple participants. Multi-destination communication and data exchange over a public network is essential for such applications. Some applications, generally referred to herein as “broadcasting applications,” are characterized by a small number of sending parties and a large, dynamically changing group of receiving parties. Other applications referred to herein as “conferencing applications” involve a large number of sending and receiving participants.

When a group of people wants to communicate over a public network such as the Internet in a conference, all other participants receive every message sent out by one of the participants. The mechanism used to accomplish this type of communication is referred to as multicast. Any Internet subscriber or user with access to a public network may subscribe to a multicast group and subsequently receives all messages sent to this multicast group. Additionally, any multicast participant is able to send messages to the whole group.

Multicast is rapidly becoming an important mode of communication as well as an effective platform for building group-oriented services. However, to be used for secure or trusted communication, tools for protecting (i.e., encrypting and authenticating) traffic, controlling participation are needed to supplement existing multicast techniques, and restricting access from unauthorized users.

The need for secure electronic information exchange over insecure public networks is becoming increasingly important. As compared to conventional unicast, i.e., point-to-point, multicast is more susceptible to attack. Multicast transmissions present substantially more opportunities for interception of the traffic due to the existence of multiple senders and receivers such that the message is potentially distributed over the whole network. When an attack occurs, a large number of multicast participants are affected. Further, because multicast addresses are often well-known, multicast addresses are easily targeted for attacks. Moreover, multicast typically involves a large number of authorized users, in which a legitimate user is more difficult to distinguish from an attacker acting in parallel. While secure unicast communications are well understood, prior attempts at secure multicast communication have difficulty in scaling to large groups and handling groups with highly dynamic membership.

Two types of secrecy are typically desirable to secure electronic information: forward secrecy and backward secrecy. Forward secrecy prevents a user who has left a secure group from accessing future secure keys. Backward secrecy prevents a newly joined user from accessing past secure keys.

The basic mechanism to provide backward secrecy is to use a symmetric key, and a cryptographically strong one-way function. The key is typically a random string having a length between 128 bits to 256 bits. Further, the one-way function is typically implemented as one of the following: Secure Hash Algorithm (SHA), Data Encryption Standard (DES), MD5, etc. Thus, whenever the key (K) is put through the one-way function the result is a new key (K′) that only depends on the input key (K). While the one-way function is public and the key (K) is private, the nature of the one-way functions is such that anyone obtaining the new key (K′) is unable to reconstruct the key (K).

Additionally, the new key (K′) may be input into the one-way function to produce a subsequent key (K″). It is known in the art that from any set of Kⁿ⁺¹ that Kⁿ cannot be derived.

One prior art solution that implements backward secrecy is VersaKey (see U.S. Pat. No. 6,049,878 and U.S. Pat. No. 6,195,751). In this one-to-many solution, a sender notifies one or more recipients (in a one-way communication) to put their current key (K) through a one-way function (e.g., MD5, SHA, etc.) This results in the new key (K′) depending on the current key (K), but to derive the current key (K) from the new key (K′) is practically infeasible. Thus, the secure group now uses the new key (K′) to send messages, until such time that a sender initiates another notification to out the new key (K′) through another one-way function.

FIG. 1 illustrates a prior art system used to ensure backward secrecy. A sender (2) is operatively connected to a number of members (4, 6, 8, and 10). Each of the members (4, 6, 8, and 10) currently uses the same key (K). At any given time the Key Management System (KMS) (12) sends a notification (14) indicating that each of the members (4, 6, 8, and 10) apply a one-way function to the key (K) to generate a new key (K′). The result is that now every member (4, 6, 8, and 10) uses the new key (K′) to encrypt communications to other members (4, 6, 8, and 10) in the group.

### SUMMARY OF INVENTION

In general, in one aspect, the invention relates to a method for updating a key in a secure group. The method comprises issuing an update request by a first member of the secure group, receiving the update request by a second member of the secure group, generating a first suggested revision number by the first member, generating a second suggested revision number by the second member in response to the update request, calculating a first send time by the first member using the first suggested revision number, calculating a second send time by the second member using the second suggested revision number, sending the first suggested revision number by the first member upon reaching the first send time if the first member is not blocked from sending, sending the second suggested revision number by the second member upon reaching the second send time if the second member is not blocked from sending, receiving the first suggested revision number by the second member, comparing the first suggested revision number to the second suggested revision number by the second member, blocking the second member from sending if the first suggested revision number is more than the second suggested revision number, and updating the key on the first member and the second member using the first suggested revision.

In general, in one aspect, the invention relates to a computer system to update a key in a secure group. The computer system comprises a processor, a memory, and software instructions. The software instructions are stored in the memory for enabling the computer system under control of the processor, to perform issuing an update request by a first member of the secure group, receiving the update request by a second member of the secure group, generating a first suggested revision number by the first member, generating a second suggested revision number by the second member in response to the update request, calculating a first send time by the first member using the first suggested revision number, calculating a second send time by the second member using the second suggested revision number, sending the first suggested revision number by the first member upon reaching the first send time if the first member is not blocked from sending, sending the second suggested revision number by the second member upon reaching the second send time if the second member is not blocked from sending, receiving the first suggested revision number by the second member, comparing the first suggested revision number to the second suggested revision number by the second member, blocking the second member from sending if the first suggested revision number is more than the second suggested revision number, and updating the key on the first member and the second member using the first suggested revision.

In general, in one aspect, the invention relates to an apparatus for updating a key in a secure group. The apparatus comprises means for issuing an update request by a first member of the secure group, means for receiving the update request by a second member of the secure group, means for generating a first suggested revision number by the first member, means for generating a second suggested revision number by the second member in response to the update request, means for calculating a first send time by the first member using the first suggested revision number, means for calculating a second send time by the second member using the second suggested revision number, means for sending the first suggested revision number by the first member upon reaching the first send time if the first member is not blocked from sending, means for sending the second suggested revision number by the second member upon reaching the second send time if the second member is not blocked from sending, means for receiving the first suggested revision number by the second member, means for comparing the first suggested revision number to the second suggested revision number by the second member, means for blocking the second member from sending if the first suggested revision number is more than the second suggested revision number, and means for updating the key on the first member and the second member using the first suggested revision.

In general, in one aspect, the invention relates to a method for updating a key in a secure group having a plurality of members. The method comprises issuing an update request by one of the plurality of members, receiving the update request by the plurality of members, suggesting and storing a stored revision number by each of the plurality of members, calculating a send time for each of the plurality of members using the stored revision number, sending a suggested revision number by a propagating member of the plurality of members to each of the plurality of members if the send time is reached and the propagating member is not blocked, receiving the suggested revision number by each of the plurality of members, blocking each of the plurality of members if the stored revision number for each of the plurality of members is less than the suggested revision number, storing the stored revision number in a suggested revision number message for each of the plurality of members if the stored revision number for each of the plurality of members is less than the suggested revision number, and updating the key using the stored revision number if a time limit has expired.

In general, in one aspect, the invention relates to an apparatus for updating a key in a secure group having a plurality of members. The apparatus comprises means for issuing an update request by one of the plurality of members means for receiving the update request by the plurality of members, means for suggesting and storing a stored revision number by each of the plurality of members, means for calculating a send time for each of the plurality of members using the stored revision number, means for sending a suggested revision number by a propagating member of the plurality of members to each of the plurality of members if the send time is reached and the propagating member is not blocked, means for receiving the suggested revision number by each of the plurality of members, means for blocking each of the plurality of members if the stored revision number for each of the plurality of members is less than the suggested revision number, means for storing the stored revision number in a suggested revision number message for each of the plurality of members if the stored revision number for each of the plurality of members is less than the suggested revision number, and means for updating the key using the stored revision number if a time limit has expired.

Other aspects and advantages of the invention will be apparent from the following description and the appended claims.

### BRIEF DESCRIPTION OF DRAWINGS

FIG. 1 illustrates a prior art system used to ensure backward secrecy.

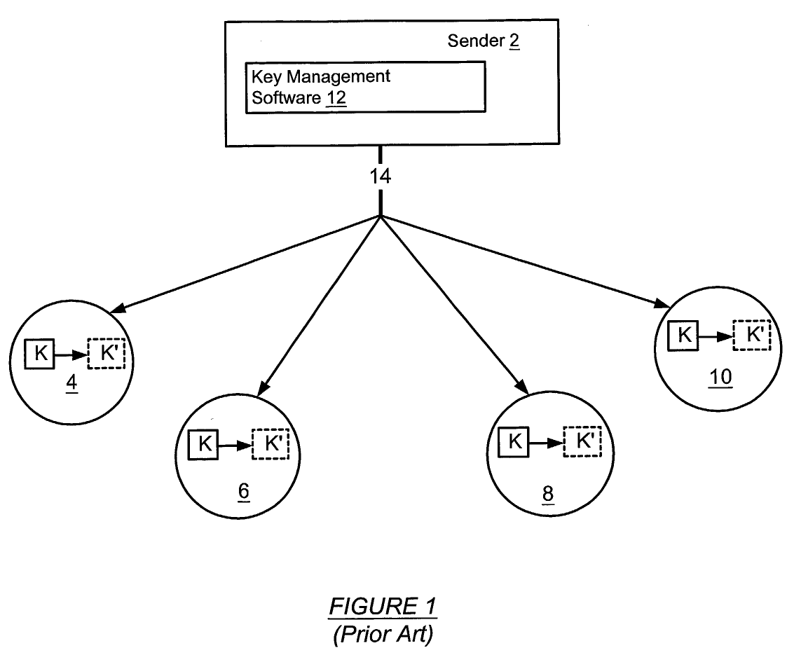

FIG. 2 illustrates a method for determining the new revision number in accordance with one or more embodiments of the invention.

FIG. 3 illustrates a system in accordance with one or more embodiments of the invention.

### DETAILED DESCRIPTION

Exemplary embodiments of the invention will be described with reference to the accompanying drawings. Like elements are denoted by reference numbers throughout the drawings for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The invention relates to a method for ensuring group-wise backward secrecy. Further, the invention relates to allowing any member in a secure group to initiate a key change. Further, the invention relates to allowing each member in the group to suggest what the new key should be changed to. Further, the invention relates to a time-based method for determining which of the new keys, suggested by the group members, should be used.

In accordance with one embodiment of the invention, every member in a secure group may initiate a request to change the key. Further, each member within the group may suggest a potential new key. In accordance with one embodiment of the invention, a new version of the key is suggested as opposed to an actual new key. Thus, for a given key (K) a member may suggest that the new key (Kⁿ) result from applying a given one-way function to the key (K) N number of times. For the purposes of the following discussion, the term N described above will be denoted as “a revision number.”

When a new member joins the group, the new member receives Kⁿ and the revision number via a secure channel. In more detail, a group member admitting the new member requests a revision change of K from the old revision number (N−1) to the new revision number, and forwards to the new Kⁿ and revision number to the new member. The new member, depending on key management protocol, may also receive a full or partial list of other members, group channels, etc.

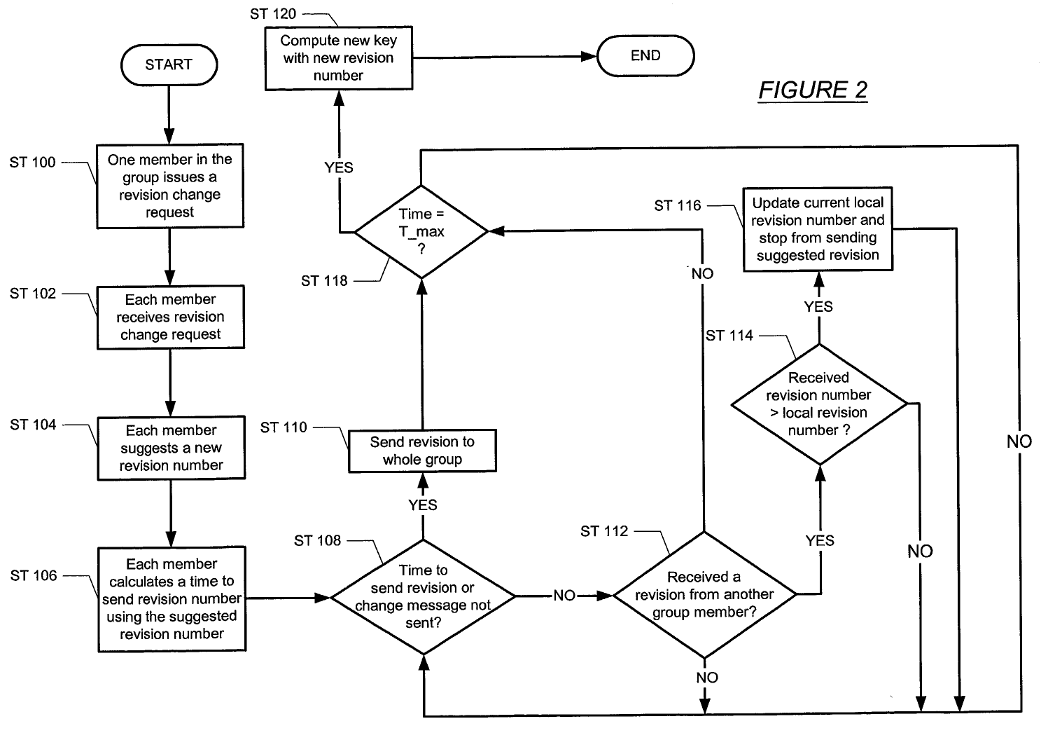

In the many-to-many relationship described above, a mechanism determines which suggested revision number is to be used by the entire group. FIG. 2 illustrates a method for determining the new revision number in accordance with one embodiment of the invention. Initially, one member in the group issues a request for a revision change (Step 100). Each member subsequently receives the revision change request (Step 102). Each member in the group then suggests a new revision number (R_sug) (Step 104). Using R_sug, a time (t_send) to send R_sug to the rest of the group is calculated (Step 106).

In one embodiment of the invention, t_send is calculated using the following formula: t_send=t_max/(log (R_sug−R_current)). In the formula, t_max is an arbitrary time in which members in the group may send R_sug. In one embodiment of the invention, t_max is set at 20 seconds. Further, R_current is the current revision number associated with the current key. Additionally, R_sug cannot be less than or equal to R_current, i.e., R_sug>R_current.

The result of using the above described t_send formula is that the greater the difference between R_sug and R_current, the earlier R_sug is sent to the other members in the group. Further, in one embodiment of the invention, t_send is calculated with reference to a system clock of the group member that sent the request for a revision change.

Returning to FIG. 2, if the time to send R_sug has been reached (i.e., current time=t_send) (Step 108) then R_sug is sent to the rest of the group (Step 110). If the time to send R_sug has not been reached or R_sug has already been sent (Step 108), then the member determines if another R_sug has been received from another member (Step 112). If another R_sug has not been received from another member then the method proceeds to Step 108. If another R_sug is received from another member (Step 112), then the member determines if the received R_sug (i.e., another R_sug) is greater than or equal to the local R_sug (i.e., the R_sug suggested by the member receiving another R_sug) (Step 114). If the received R_sug (i.e., received R_sug) is less than the local R_sug, then the method returns to Step 108. If the received R_sug is greater or equal to the local R_sug, (Step 114) then R_sug is updated to equal the received R_sug and the member is blocked from sending the local R_sug (Step 116). The method then returns to step 108.

If the time to send R_sug expires (i.e., time=T_max) (Step 118), then the R_sug (either local or updated depending on received R_sug) is input into the one-way function to generate the new key. If the time to send R_sug has not expired, then the method proceeds to Step 108.

In one or more embodiments of the invention, the method illustrated in FIG. 2 may be modified to include criteria for key change. The criteria for key change may require that a key change may not be requested, unless a message is sent before. The criteria allows current members in the secure group to remove misbehaving members from the secure group. This extension to the method may also lengthen the window of de-synchronization in certain scenarios.

In one or more embodiments of the invention, the revision change requests are authenticated prior to initiating a revision change, as illustrated in FIG. 2. In one or more embodiments of the invention, hash-cash is used to authenticate the revision change request. Hash cash is payment in burnt CPU cycles by calculating n-bit partial hash collisions on chosen texts. The idea of using partial hashes is that they can be made arbitrarily expensive to compute (by choosing the desired number of bits of collision), and yet can be verified instantly. Such hash-cash systems can be used to throttle systematic abuses of un-metered internet resources. Thus, using hash-cash would require any participant that wants to initiate a revision change to spend significant amounts of computing power to generate the revision change request. The addition of hash-cash may be used to mitigate denial of service attacks, especially if t (i.e., the time to send the suggested revision number) is smaller than the time a potential attacker needs to generate the hash-cash required as part of the revision change request.

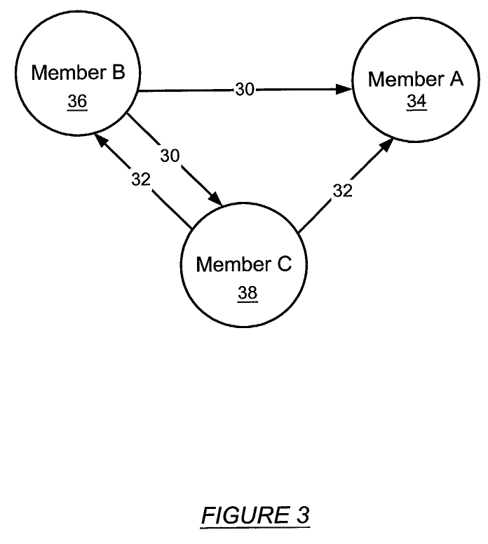

FIG. 3 illustrates a system in accordance with one embodiment of the invention. The system includes three members: Member A (34), Member B (36), and Member C (38). Member B (36) initiates a request to change the revision number (30). The request may be received directly by Member A (34), in the current system topology, or received directly by Member C (38). Each member (Member A (34), Member B (36), and Member C (38) subsequently decides upon a revision number that the member wishes to suggest as a new revision number. Each member calculates the time to send the suggested revision. In this particular case, Member C (38) waits the least amount of time to send the suggested revision (32). The suggested revision (32) is propagated by the propagating member, Member C (38) directly to each of the other members (i.e., Member A (34) and Member B (36). In this particular situation, the revision suggested by Member C (38) is greater than the other revision numbers suggested by other members, as Member C (38) sent out the first and only suggested revision request. Upon receipt of the revision request (32), each member subsequently adopts the revision suggested by Member C (38) and is restricted from sending a subsequent revision message. While the system described in FIG. 3 includes three members of a group directly connected to one another, one skilled in the art will appreciate that fewer or additional members may be included and that the members may be dispersed across a network requiring multiple hops over a widely distributed network system.

The invention may include one or more of the following advantages. The invention provides a means for perfect group-wise backward secrecy. Further, the invention allows any member in a group to request a new key (i.e., a new revision change), and any member in the group to suggest a new key. Further, the invention allows for efficient synchronization of a key or key material for a group after a netsplit (i.e., a disconnection of one server from another server). Further, the invention allows for efficient synchronization of a key or keying material whenever a group re-forms after a period of absence by some or all of the group's members. Further, the invention provides an efficient solution to preserve perfect backward secrecy in a group with dynamic membership. Those skilled in the art appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for updating a key in a secure group comprising:
issuing an update request by a first member of the secure group;
receiving the update request by a second member of the secure group;
generating a first suggested revision number by the first member;
generating a second suggested revision number by the second member in response to the update request;
calculating a first send time by the first member using the first suggested revision number;
calculating a second send time by the second member using the second suggested revision number;
sending the first suggested revision number by the first member upon reaching the first send time if the first member is not blocked from sending;
sending the second suggested revision number by the second member upon reaching the second send time if the second member is not blocked from sending;
receiving the first suggested revision number by the second member;
comparing the first suggested revision number to the second suggested revision number by the second member;
blocking the second member from sending if the first suggested revision number is more than the second suggested revision number; and
updating the key on the first member and the second member using the first suggested revision.

2. The method of claim 1, wherein the key is a symmetric key.

3. The method of claim 1, wherein the first send time is dependent on the difference between the first suggested revision number and a current revision number of the key.

4. The method of claim 1, wherein the second send time is dependent on the difference between a second suggested revision number and a current revision number of the key.

5. The method of claim 1, updating the key comprising using a one-way function.

6. The method of claim 5, wherein the one-way function is MD5.

7. The method of claim 5, wherein the one-way function is Secure Hash Algorithm.

8. The method of claim 1, wherein the update request is authenticated using a digital signature.

9. The method of claim 1, wherein the first member and the second member maintain a copy of a current key and a corresponding revision number.

10. The method of claim 1, further comprising:
calculating the first send time with reference to a system clock of the first member.

11. The method of claim 1, further comprising:
calculating the second send time with reference to a system clock of the second member.

12. The method of claim 1, further comprising:
calculating the first send time with reference to a system clock of the first member; and
calculating the second send time with reference to a system clock of the second member.

13. A computer system to update a key in a secure group comprising:
a processor;
a memory; and
software instructions stored in the memory for enabling the computer system under control of the processor, to perform:
issuing an update request by a first member of the secure group;
receiving the update request by a second member of the secure group;
generating a first suggested revision number by the first member;
generating a second suggested revision number by the second member in response to the update request;
calculating a first send time by the first member using the first suggested revision number;
calculating a second send time by the second member using the second suggested revision number;
sending the first suggested revision number by the first member upon reaching the first send time if the first member is not blocked from sending;
sending the second suggested revision number by the second member upon reaching the second send time if the second member is not blocked from sending;
receiving the first suggested revision number by the second member;
comparing the first suggested revision number to the second suggested revision number by the second member;
blocking the second member from sending if the first suggested revision number is more than the second suggested revision number; and
updating the key on the first member and the second member using the first suggested revision.

14. The computer system of claim 13, wherein the key is a symmetric key.

15. The computer system of claim 13, wherein the first send time is dependent on the difference between the first suggested revision number and a current revision number of the key.

16. The computer system of claim 13, wherein the second send time is dependent on the difference between a second suggested revision number and a current revision number of the key.

17. The computer system of claim 13, the updating the key comprising using a one-way function.

18. The computer system of claim 17, wherein the one-way function is MD5.

19. The computer system of claim 17, wherein the one-way function is Secure Hash Algorithm.

20. The computer system of claim 17, wherein the update request is authenticated using a digital signature.

21. The computer system of claim 17, wherein the first member and the second member maintain a copy of a current key and a corresponding revision number.

22. An apparatus for updating a key in a secure group comprising:
means for issuing an update request by a first member of the secure group;
means for receiving the update request by a second member of the secure group;
means for generating a first suggested revision number by the first member;
means for generating a second suggested revision number by the second member in response to the update request;
means for calculating a first send time by the first member using the first suggested revision number;
means for calculating a second send time by the second member using the second suggested revision number;
means for sending the first suggested revision number by the first member upon reaching the first send time if the first member is not blocked from sending;
means for sending the second suggested revision number by the second member upon reaching the second send time if the second member is not blocked from sending;
means for receiving the first suggested revision number by the second member;
means for comparing the first suggested revision number to the second suggested revision number by the second member;
means for blocking the second member from sending if the first suggested revision number is more than the second suggested revision number; and
means for updating the key on the first member and the second member using the first suggested revision.

23. A method for updating a key in a secure group having a plurality of members, comprising:
issuing an update request by one of the plurality of members;
receiving the update request by the plurality of members;
suggesting and storing a stored revision number by each of the plurality of members;
calculating a send time for each of the plurality of members using the stored revision number;
sending a suggested revision number by a propagating member of the plurality of members to each of the plurality of members if the send time is reached and the propagating member is not blocked;
receiving the suggested revision number by each of the plurality of members;
blocking each of the plurality of members if the stored revision number for each of the plurality of members is less than the suggested revision number;
storing the stored revision number in a suggested revision number message for each of the plurality of members if the stored revision number for each of the plurality of members is less than the suggested revision number; and
updating the key using the stored revision number if a time limit has expired.

24. The method of claim 23, wherein the key is a symmetric key.

25. The method of claim 23, updating the key comprising using a one-way function.

26. The method of claim 25, wherein the one-way function is MD5.

27. The method of claim 25, wherein the one-way function is Secure Hash Algorithm.

28. The method of claim 23, wherein the update request is authenticated using a digital signature.

29. The method of claim 23, further comprising:
authenticating a message comprising the suggested revision number.

30. The method of claim 23, further comprising:
authenticating a message comprising the suggested revision number using a hash-cash.

31. The method of claim 23, further comprising:
calculating the send time with reference to a system clock of one of the plurality of members that requested issuing the update request.

32. An apparatus for updating a key in a secure group having a plurality of members, comprising:
means for issuing an update request by one of the plurality of members;
means for receiving the update request by the plurality of members;
means for suggesting and storing a stored revision number by each of the plurality of members;
means for calculating a send time for each of the plurality of members using the stored revision number;
means for sending a suggested revision number by a propagating member of the plurality of members to each of the plurality of members if the send time is reached and the propagating member is not blocked;
means for receiving the suggested revision number by each of the plurality of members;
means for blocking each of the plurality of members if the stored revision number for each of the plurality of members is less than the suggested revision number;
means for storing the stored revision number in a suggested revision number message for each of the plurality of members if the stored revision number for each of the plurality of members is less than the suggested revision number; and
means for updating the key using the stored revision number if a time limit has expired.
